(19) United States
(12) Patent Application Publication
(10) Pub. No.: US 2005/0255374 A1
(43) Pub. Date: Nov. 17, 2005

(54) Fuel cell

(75) Inventors: Evgeny Kulakov, Toronto (CA); Serg Kimberg, North York (CA)

Correspondence Address: MORGAN LEWIS & BOCKIUS LLP, 1111 PENNSYLVANIA AVENUE NW, WASHINGTON, DC, 20004, US

(73) Assignee: Atlantic Pacific Fuel Cell Corporation

(21) Appl. No.: 11/125,252

(22) Filed: May 10, 2005

(30) Foreign Application Priority Data
May 11, 2004 (CA) 2,466,872

(51) Int. Cl. H01M 4/96; H01M 8/10; H01M 4/94

(52) U.S. Cl. 429/44; 429/30; 429/33

(57) ABSTRACT

A gas diffusion electrode for use in a fuel cell assembly of a fuel cell for use with a source of gaseous reductant and a source of gaseous oxidant. The assembly comprises a central ionic membrane having a membrane first surface and a membrane second surface; a first matrix formed of an organic polymer having a first matrix first surface in contact with the membrane first surface and a first matrix second surface; a second matrix formed of an organic polymer having a second matrix first surface in contact with the membrane second surface and a second matrix second surface; a first current collector within the first matrix; a second current collector within the second matrix and in electrical communication with the first current collector; wherein each of the first and the second matrices has a pore structure as to allow of gas permeation within the matrix and water exudation out of the matrix, and contains particulate carbon and wherein at least a portion of each of the first and the second matrices contain catalytic material-coated particulate carbon as to constitute catalytic portion. The fuel cell provides electrochemical and mechanical performance and a stabilized current voltage output under varying load conditions.

### FIELD OF THE INVENTION

This invention relates to fuel cells, particularly said full cells using oxygen-containing and hydrogen gaseous reactants; more particularly, to gas diffusion electrodes and fuel cell assemblies for use with said reactants; and methods of making said electrodes, assemblies and fuel cells.

### BACKGROUND OF THE INVENTION

Fuel cells in general require an anode, cathode, gas diffusion plate, hydrophilic substrate and hydrophobic substrate pressed onto an impermeable ionic conducting membrane. Prior art has favored the use of conductive gas diffusion plates as the anode and cathode. These are then be pressed against a membrane electrode assembly which is fabricated separately. The membrane electrode assembly (MEA) consists of a central membrane sandwiched between carbon doped hydrophobic matrices and further sandwiched between carbon and catalyst doped hydrophilic matrices. The hydrophobic and hydrophilic layers usually contain a polymeric material such as polytetrafluorethylene for binding carbon and the carbon polymer ratio can be adjusted to provide hydrophobicity or hydrophilicity.

The method of hot pressing the layers onto the membrane provides good adhesion and reduced porosity at the membrane polymer interface. However, the reduced porosity results in the membrane electrode assembly having high sensitivity to moisture and also gas concentration. This lack of porosity is further aggravated by the pressure that must be applied to the anode and cathode electrode plates in order for good contact to be maintained with the MEA.

Several examples of these structures are described as follows.

U.S. Pat. No. 5,677,074, Oct. 14, 1997: Gas diffusion electrode by Serpico; Joseph M. Ehrenberg; Scott G., Wnek; Gary E. Tangredi; Timothy N. describes a gas diffusion electrode for an electrochemical cell and a fuel cell employing the electrode. The electrode includes a porous body in contact with a catalyst layer comprising (i) a catalyst dispersed on the surface of a carbon support; (ii) a water-insoluble sulfonated polystyrene, poly(.alpha.-methylstyrene) or SEBS block copolymer; and (iii) a nonionic fluorocarbon polymer. The fuel cell includes two of the foregoing electrodes and a membrane of a proton-conducting polymer between the electrodes. It also includes an inlet for a gaseous fuel, an inlet for an oxygen-containing gas, and an outlet for reaction products.

U.S. Pat. No. 3,930,094, Dec. 30, 1975: Hydrophobic mats for gas diffusion electrodes by Sampson; Ronald N. and Chottiner; Jacob describes a gas diffusion electrode having a gas entrance side and an electrolyte contacting side contains an electrical conductor and a hydrophobic outer layer on the gas entrance side, the hydrophobic outer layer comprising a mat containing fibrillated very high molecular weight polyethylene. The woven or mat structure provides some strength and gas porosity.

A major limitation of the current art is that the layers adjacent the impermeable membrane have little porosity and low surface area. Furthermore, the conductive anodes and cathodes must be pressed against the MEA structure to minimize contact resistance. This lack of porosity prevents the structure from having much capacity for adsorbing the reactant gases, oxygen and hydrogen. Thus, current and voltage instabilities can occur during operation.

There is therefor a need for fuel cells which do not suffer from the aforesaid disadvantages.

### SUMMARY OF THE INVENTION

It is an object of the present invention to provide an improved gas diffusion electrode having a current collector embedded in a polymer matrix doped with particulate carbon, partially coated with a catalytic material.

It is a further object of the invention to provide a fuel cell assembly having polymer matrices structures with integrated current collectors bonded to an impermeable membrane and which are doped with particulate carbon to provide the desired hydrophobicity to the matrix.

It is a further object of the present invention to provide a fuel cell assembly having polymer matrices structures bonded to an impermeable membrane and having integrated current collectors which are catalyzed by electrochemical reduction of metal salts from solution to provide strongly bound catalyst particles which are all in electrical contact with the current collector mesh.

It is a further object to provide a fuel cell having a polymer with a relatively high surface area that can stabilize current and voltage behavior by absorbing the reactant hydrogen or oxygen gases into the porous polymer structure.

It is a further object to provide said fuel cell by means of bonding the polymer matrix to the impermeable membrane and to the current collector using pressure and temperature while maintaining the porosity of the matrix.

It is a further object to provide a fuel cell that has good electrochemical and mechanical performance and a stabilized current voltage output under varying load conditions.

Accordingly, in one aspect the invention provides a fuel cell assembly for use with a source of gaseous reductant and a source of gaseous oxidant, said assembly comprising:
a central ionic membrane having a membrane first surface and a membrane second surface;
a first matrix formed of an organic polymer having a first matrix first surface in contact with said membrane first surface and a first matrix second surface;
a second matrix formed of an organic polymer having a second matrix first surface in contact with said membrane second surface and a second matrix second surface;
a first current collector within said first matrix;
a second current collector within said second matrix and in electrical communication with said first current collector;
wherein each of said first and said second matrices has a pore structure as to allow of gas permeation within the matrix and water exudation out of said matrix, and contains particulate carbon and wherein at least a portion of each of said first and said second matrices contain catalytic material-coated particulate carbon as to constitute a catalytic portion.

Each of said matrices is preferably hydrophobic.

Preferably, the catalytic portions of each of the first and second matrices containing the catalytic material-coated particulate carbon are at the first and second matrices second surfaces.

Most preferably, the catalytic material-coated particulate carbon in the first matrix is in electrical contact with the first current collector; and the catalytic material-coated particulate carbon in the second matrix is in electrical contact with the second current collector.

In alternative embodiments, further portions of each of said first and second matrices containing said catalytic material-coated particulate carbon are present but are essentially limited at or adjacent to said first and second matrices first surfaces as to constitute further catalytic portions.

Each of the first and second matrices has at least an effective minimum gaseous porosity, preferably of at least 0.1 μm diameter.

The assemblies as hereinabove defined has each of the current collectors in the form of a foraminous member to allow of the passage therethrough of gaseous molecules.

Most preferably, the current collector is a metallic conductor, in the form of a mesh, grid or the like and formed of a first transition series metal

Examples of collectors of preferred use in the invention are formed of nickel, copper, iron and alloys thereof, and most preferably, nickel.

The catalytic material is preferably selected from a noble metal, a precious metal, or mixtures thereof. Preferably, Pd, Pt, Os, Ir and Ru.

A preferred example of the hydrophobic matrix polymer is a high density polyethylene.

We have, surprisingly, found that application of an aqueous solution of a salt of the catalytic material, e.g. platinum chloride, palladium chloride or mixtures thereof, to a surface of a matrix of use in the practise of the invention causes the deposition of the metal as metallic clusters on the conductive carbon sites on the surface.

Control of the catalyst density or size of the metallic catalyst clusters is achieved by increasing or decreasing the precious metal chloride concentration and by increasing or decreasing the contract time of the gas diffusion electrode with the chloride solution. The chloride solutions are allowed to contact the surface of the gas diffusion electrode using the commonly employed techniques of spray, brush sponging or preferably, immersing the electrode in the solution. Typical concentrations are about 10 mg/l metal chloride and contact times of about 10-30 min.

This advantageous spontaneous electrochemical reduction of precious metal chlorides appears to specifically occur at surface sites which are in electrical contact with the conductor grid within the matrix and, thus, maximize the effectiveness of the catalyst deposit. Clearly, catalyst which is precipitated, according to the prior art, by chemical or thermal means in a gas diffusion electrode may end up on isolated carbon particles or on non-conductive polymeric substrate and, hence, do not perform a useful function of facilitating electron transfer between the reactant gas and current collector. Thus, the gas diffusion electrodes of the present invention with the imbedded nickel metal mesh collector, advantageously, allows catalyst to be formed on active sites and avoids the need for additional catalyst reduction stages.

Preferably, Pt catalyst is electrochemically bound on the cathode side of the assembly, and Pt/Pd alloy on the anode side.

In a further aspect, the invention as hereinabove defined provides a fuel cell assembly provided with oxidant feed, preferably air, means in communication with the first matrix and reductant feed, preferably hydrogen, means in communication with the second matrix.

In yet a further aspect, the invention provides a gas diffusion electrode for use with a fuel cell comprising a matrix formed of an organic polymer having
(i) a pore structure as to allow of gas permeation within and water exudation out of said matrix;
(ii) a first surface;
(iii) a second surface; and
(iv) a current collector embedded within said matrix; wherein said matrix contains particulate carbon and wherein at least a portion of said particulate carbon is coated with catalytic material as to constitute a catalytic portion.

Preferably, the matrices are hydrophobic.

Most preferably, the catalytic portion of the catalytic material-coated carbon is essentially limited at or adjacent to the first surface.

In further embodiments the catalytic portion of the catalytic material-coated carbon is essentially limited at or adjacent to both of the first and second surfaces.

The current collector, the catalytic material, the porosities, polymer, catalytic material ratios and catalytic portions are as hereinabove defined.

In a yet further aspect, the invention provides a method of making a fuel cell assembly as hereinabove defined comprising embedding said first current collector in said first particulate carbon-containing hydrophobic matrix; embedding said second current collector in said second particulate carbon-containing hydrophobic matrix; locating said central membrane between said first and second matrixes; and treating said first and said second matrixes with a solution of a compound of said catalytic material in an oxidation state to effect reduction to said catalytic material and production of said catalytic material-coated particulate carbon.

### BRIEF DESCRIPTION OF THE DRAWINGS

In order that the invention may be better understood, preferred embodiments will now be described by way of example only with reference to the accompanying drawings wherein:—

FIG. 1 represents a partially exploded schematic cross-sectional view of a prior art membrane electrode assembly;

FIGS. 2 and 2A represent schematic vertical sectional views (in part) of a gas diffusion electrode of use in a membrane electrode assembly and fuel cell according to the present invention;

FIGS. 3 and 3A represent schematic diagrammatic sectional views of a membrane electrode assembly according to the invention;

FIG. 4 represents an electron micrograph of a Pt/Pd electrode anode;

FIG. 5 represents an electron micrograph cross-section of a Pt/Pd sphere coated wire;

FIG. 6 represents a diagrammatic a graph of voltage vs. current density for a membrane electrode assembly according to the prior art;

FIG. 7 is a graph of voltage vs. time characteristics for a membrane electrode assembly according to the prior art invention;

FIG. 8 is a graph of voltage vs. current density for a membrane electrode assembly according to the prior art influenced by a hydrogen purge;

FIG. 9 is a graph of voltage vs. time characteristics for a membrane electrode assembly according to the prior art influenced by a hydrogen purge;

FIG. 10 is a graph of voltage vs. current density for a membrane electrode assembly according to the invention;

FIG. 11 is a graph of voltage vs. time characteristics for a MEA according to the invention;

FIG. 12 is a graph of discharge characteristic vs. time for a MEA according to the invention; and wherein the same numerals denote like parts.

### DETAILED DESCRIPTION OF PREFERRED EMBODIMENTS

Table 1 shows a list of nickel and chemical components, their sources, a physical characteristic, and amounts of the components used in the preparation of a gas diffusion electrode according to the invention.

A gas diffusion electrode was made as follows by:
1. blending the components in a Banbury mixer in the following amounts:—
   Component A—560 g; (90%)
   Component B—59.1 g; (9.5%)
   Component C—3.1 g; (0.5%)
2. adding Component D after blending in an amount of 572 mL (20 Vol % of whole weight of the above components) and blended to an homogeneous state;
3. extruding with the nickel mesh (Component E), placed into the middle of the thickness of the polymer mass which was subsequently calendered to give the desired gas diffusion electrode profile of width and thickness;
4. locating the profile (band) in a mineral oil removal extraction chamber with solvent, removed carbon tetrachloride (Component F) @ the temperature of 75-85% of the boiling point (76.7° C.) for one hour; and
5. the band dried @ the ambient temperature about 21° C. and 45% of relative humidity for 24 hours.
   Alternatively, the nickel mesh current collector was embedded in the matrix during the forming stage, for example, by locating it within or pressing it into the surface while the matrix was hot.
   A catalytic material of Pt deposit was applied with a brush to either a single or both profile surfaces as a PtCl₂ or PtCl₂/PdCl₂ solution (10 mg/l) through successive coatings. After each coating the electrodes were heated to 80° C. in an oven. A resultant catalytic material deposite of about 1 to 5 mg/cm² of electrode area.
   A membrane electrode assembly was made from a pair of aforesaid gas diffusion electrodes between which was positioned proton exchange membrane (Nafion®00 NRE-212-H+ manufactured by DuPont® Fluoroproducts) and the three components subsequently pressed together at a pressure of about 40-80 Kg/com², at 120-140° C. for about 1-2 minutes.
   The resultant assembly had, thus, either a coating of catalytic material on the single surface membrane for each electrode, or a double coating, i.e. one on each of the inner and outer surfaces of each electrode.

A complete fuel cell was assembled with an aforesaid fuel cell assembly having a source of hydrogen and oxygen feeds connected thereto.

TABLE 1

| | | | Amount of components for | | | |
|---|---|---|---|---|---|---|
| | | | 100 dm² of a GDE | | | |
| | | Relative | | Volume | | |
| | | Density, | Weight | metric | Amount | Amount |
| Components | | [g/cm³] | % | % | [g] | [mL] |
| A | Vulcan XC72* | 0.26 | 90 | | 560 | 2800 |
| | Carbon Black¹ | | | | | |
| B | R1760* | 095 | 9.5 | | 59.1 | 60 |
| | HDPE - high | | | | | |
| | density | | | | | |
| | polyethylene² | | | | | |
| C | BK1675N* | 0.98 | 0.5 | | 3.1 | 2.5 |
| | Butylrubber | | | | | |
| D | M7700 | 0.95 | | 20 | | 572 |
| | Mineral Oil³ | | | | | |
| E | ColdBond, | | | | | |
| | 38 × 38 | | | | | |
| | Nickel mesh⁴ | | | | | |
| F | G022 | 1.59 | | | | 10,000 |
| | Carbon | | | | | |
| | Tetrachloride⁵ | | | | | |

*denotes trademark
¹Cabot Corp
²BCHEM International
³RTC America Inc
⁴Mallinckrodt Baker Chemicals
⁵Gerard Daniel Worldwide
⁶BOC Gases

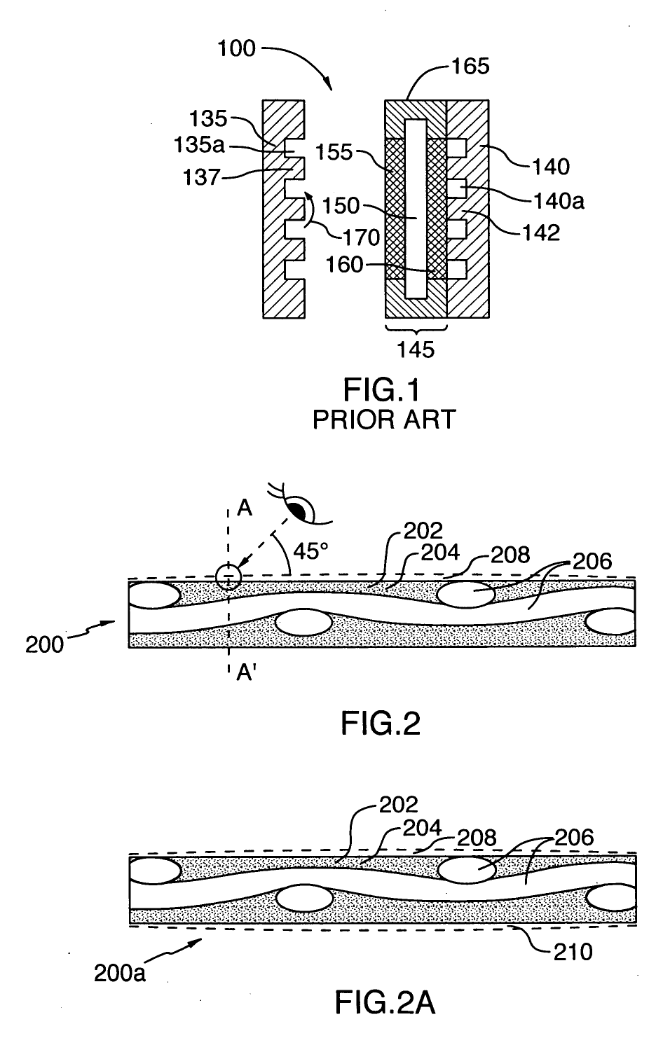

FIG. 1 represents a conventional membrane electrode assembly of use in a prior art fuel cell 100 described in U.S. Pat. No. 6,413,604—Wilkinson et al, granted Jul. 2, 2002. The fuel cell comprises a MEA having solid polymer matrixes interposed between two separator plates having a plurality of discrete fluid distribution channels.

In more detail, cell 100 comprises anode flow field plate 135, a cathode flow field plate 140, and MEA 145 interposed there between. Anode flow field plate 135 comprises discrete fuel distribution channels 135a separated by land areas 137. Cathode flow field plate 140 comprises discrete oxidant distribution channels 140a separated by land areas 142. MEA 145 comprises an electrolyte layer 150, interposed between fluid permeable anode 155 and fluid permeable cathode 160. Electro catalyst (not shown) is disposed at the interfaces between electrolyte layer 150 and anode 155 and cathode 160. It should be noted that access to the catalyst by the hydrogen fuel or oxidant air must be by gas diffusion through the anode or cathode.

FIG. 2 shows generally as 200, a vertical cross-sectional view of a gas porous hydrophobic matrix 202 of high density polyethylene polymer doped with particulate carbon 204, within which is embedded a nickel mesh current collector 206. The particles of carbon (graphite) 204 are coated with catalytic metallic platinum 208 when used as a cathode and platinum/palladium when used as an anode, which are in electrical contact with current collector 206.

FIG. 2A shows generally in 200A, an additional catalytic surface 210 on the other side of matrix 202.

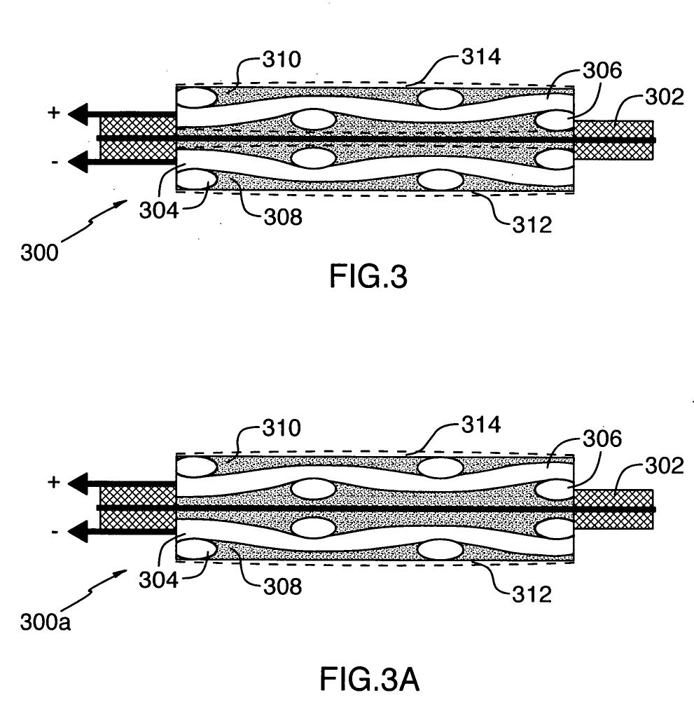

FIG. 3 shows, generally as 300, a membrane electrode assembly comprising a proton exchange membrane 302 flanked by a pair of gas diffusion electrodes 200 as shown in FIG. 2, but wherein current collectors nickel meshes 304,306 is a cathode and an anode, respectively. In more detail, 300 generally shows a cross-section of a complete fuel cell assembly wherein:—
304 is a nickel imbedded wire mesh current collector for the cathode side and 306 is a nickel imbedded wire mesh current collector for the anode side;
302 is an ionic membrane separator;
308 is a porous carbon doped HDPE polymer matrix for the cathode side and 310 is a porous carbon doped HDPE polymer matrix for the anode side;
312 is a cathode catalyst layer electrochemically bound to the cathode porous carbon doped polymer matrix; and
314 is an anode catalyst layer electrochemically bound to the anode porous carbon doped polymer matrix.

It should be noted that pressure plates according to use in the prior art are not required according to the invention, since nickel mesh current collectors 304,306 are embedded in the porous carbon loaded matrices. Further, the Pt catalyst is located on the graphite particles adjacent the “outer” surfaces of the matrices and not against the membrane, according to prior art embodiments.

FIG. 3A shows, generally in 300A, additional catalytic surfaces 312A (cathode) and 314B (anode) on the surfaces of matrices 308 and 310, respectively, each adjacent membrane 302.

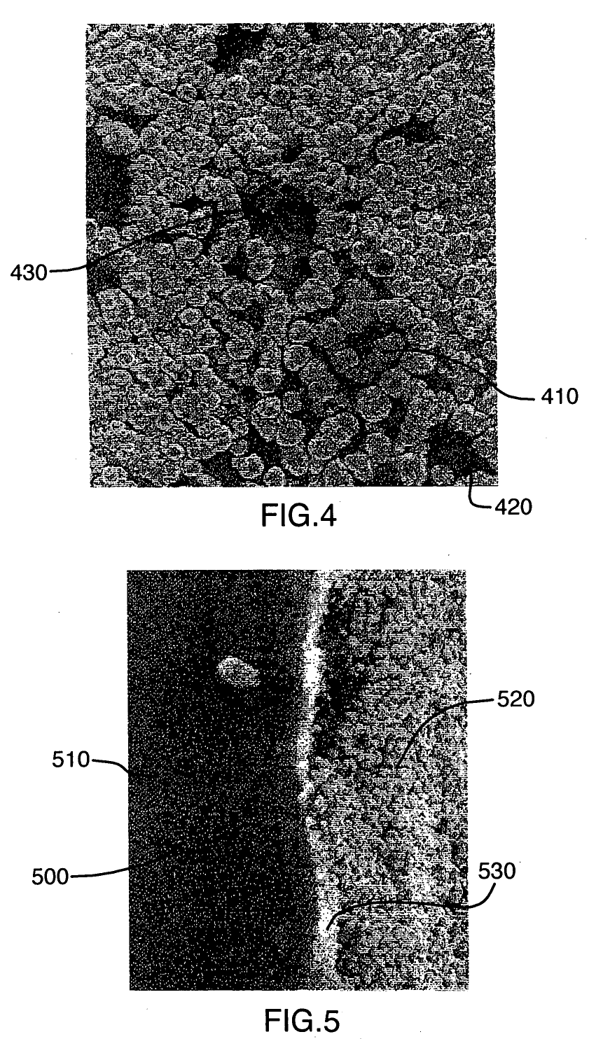

FIG. 4 represents an electron micrograph of a cross-section of a matrix showing platinum/palladium catalyst obtained by electrolytic reduction on the surface of the matrix of the membrane electrode assembly. The surface is covered with uniformly-sized 1-2 μm diameter metal spheres 410, clustered and tightly attached to the surface. None Pt/Pd coated-HDPE matrix containing particulate carbon is shown at 420. Relatively large pores are shown as 430 which allow of reactant gas permeation.

FIG. 5 represents an electron micrograph cross-section of a Pt catalyst-coated gas diffusion electrode viewed at an approximately 45° angle to the plane A-A′ normal through the matrix as shown in FIG. 2 and showing the edge of the thin, discontinuous layer of Pt catalyst spheres strictly confined to the surface of the matrix, wherein 500 represents voids/pores of approximately 0.1 μm diameter within inner matrix 510, adjacent catalyst layer 520 through sharp edge 530 of a thickness of about 3 μm.

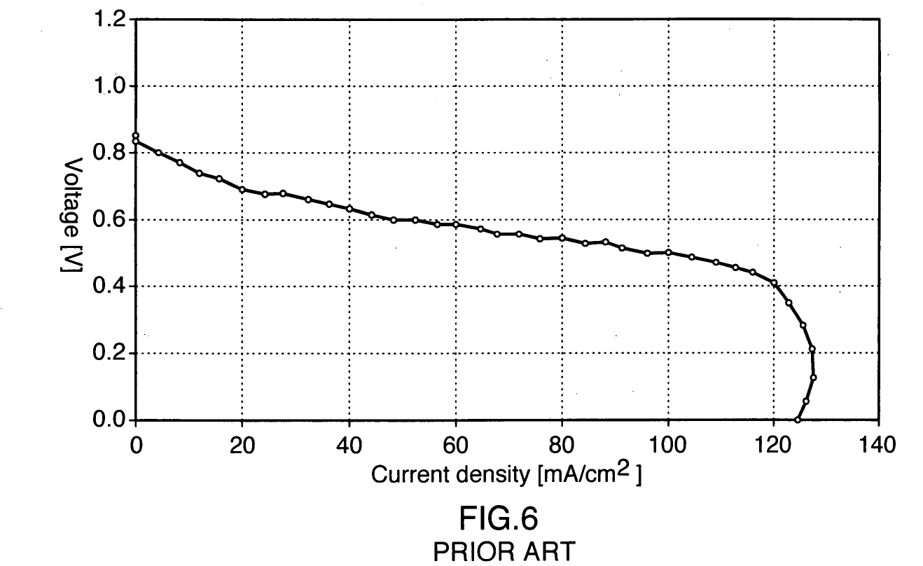

FIG. 6 represents Voltage vs. Current Density Characteristics for a DuPont® NAFION® PEM membrane-containing electrode assembly denoted as MEA-D2200 Sample T386-B-02 with Lydall gas diffusion layers type Lyflex® of the prior art.

The test conditions were:—
VA, 1(mA/cm²)/sec; ambient temperature 21° C.; air breathing; Hydrogen pressure 7 [psi] over a 25 cm² active chemical area.

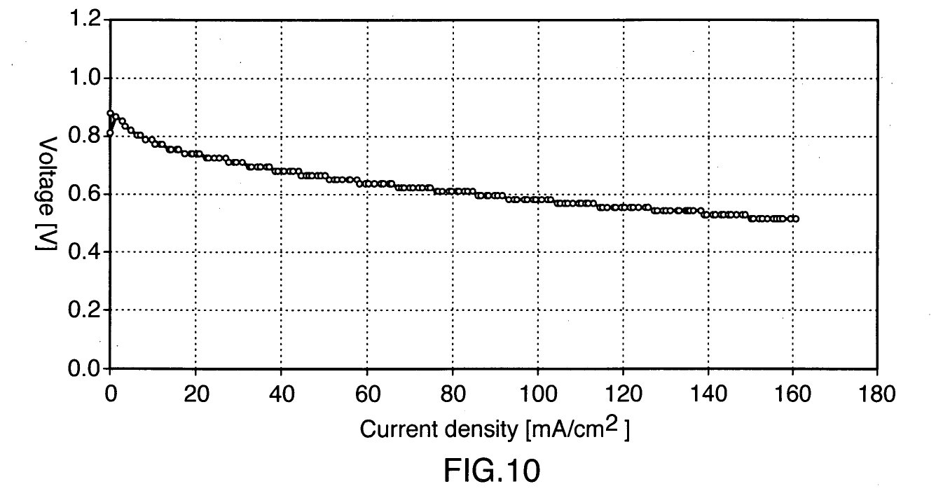

This graph shows that over time there is a steady decrease in voltage going down to zero when current density reaches 130 mA/cm². This is unlike MEA according to the invention of FIG. 10 where we still had strong voltage @ 140 mA/cm² and beyond.

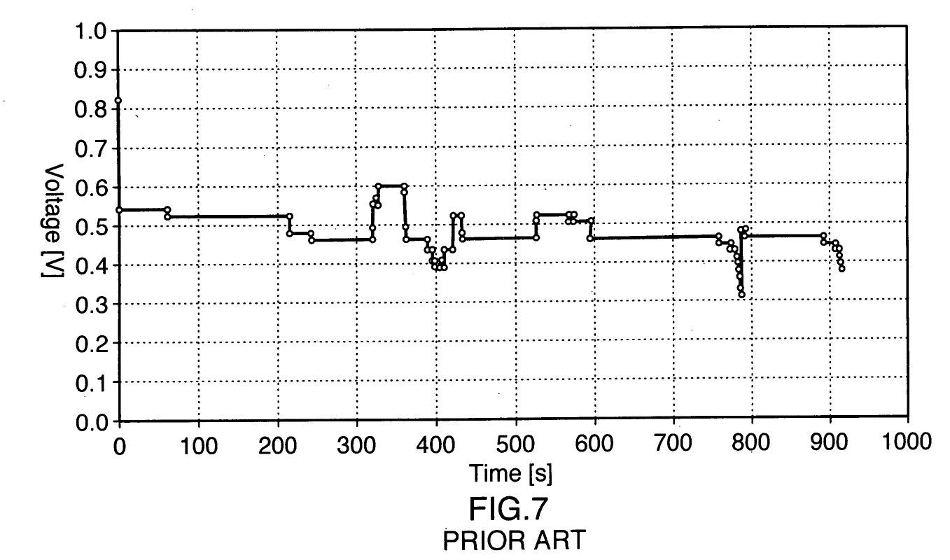

FIG. 7 is a graph of discharge characteristics of voltage vs. time according to prior art. Test included DuPont's MEA D 2200 and Lydall gas diffusion layer type Lyflex. Conditions were hydrogen 7 psi, ambient temperature 21° C., normal atmospheric pressure and a current density of 100 mA/cm² with active fuel cell area of 25 cm². This graph shows that there was an irregular flow of hydrogen that needed to be continuously monitored and purged. After each purge the voltage increased, ran at that level and then rapidly dropped which required a new purge of hydrogen.

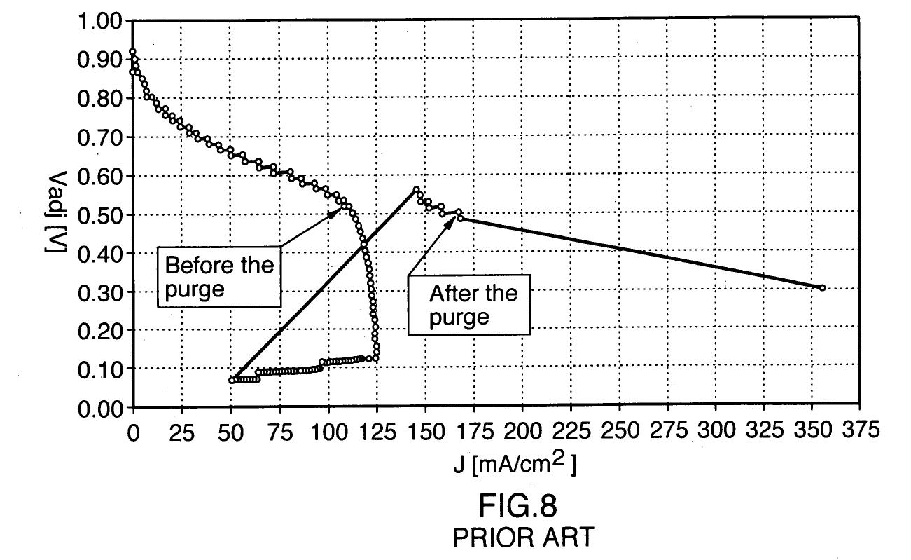

FIG. 8 is a graph showing voltage vs. current density for a MEA based upon prior art BCS Technology Inc. at conditions of hydrogen at 4 psi, normal atmospheric pressure and temperature at 21° C. The graph shows two areas before and after purge. Before purge the voltage drops dramatically, purge at about current density of 100 mA/cm² down to near zero. After the hydrogen purge, the voltage increased immediately and then dropped off slowly as the current density increased.

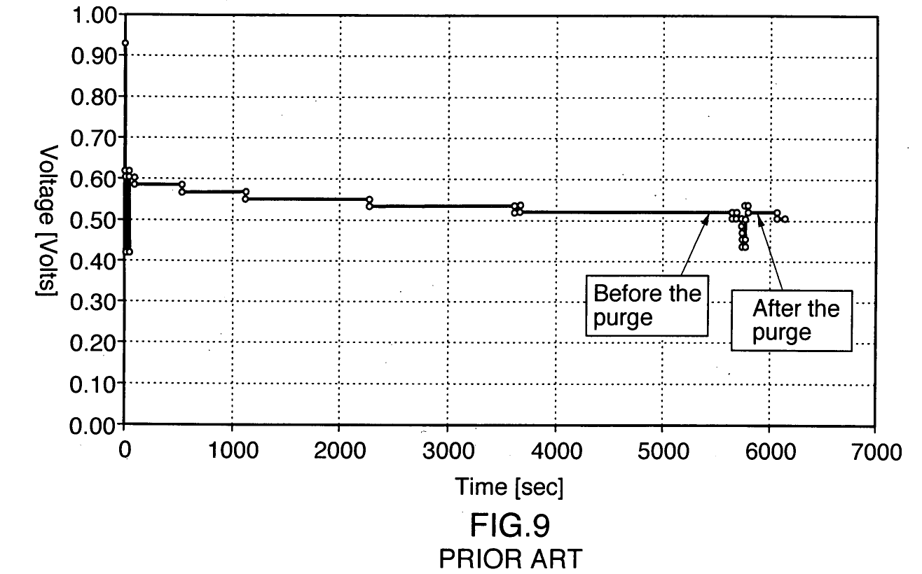

FIG. 9 is a graph of discharge characteristics Voltage vs. Time of prior art MEA based upon BCS Technology Inc. conditions same as for previous FIG. 8. FIG. 9 clearly shows a steady reduction in voltage over time that required a purge of hydrogen after 5700 seconds to restore voltage. This was unlike the test described under FIG. 7.

FIG. 10 is a graph showing voltage vs. current density with a gas diffusion electrode according to the invention and DuPont's Proton Exchange Membrane (PEM). Results are based upon standard 25 cm² of active electrochemical area with an ambient temperature of 21° C., normal atmospheric pressure and hydrogen delivered at a rate of 4 psi. FIG. 10 shows a very active gas diffusion electrode according to the invention demonstrating improved performance, since the current does not drop off significantly over time but rather decreases very slowly over time, in sharp contrast with FIGS. 6 and 8 of the prior art. For example, at 100 mA/cm² the embodiment of the invention has a voltage of 0.6 volts, which is in contrast to the prior art MEA of FIG. 6 which has a voltage of 0.55 volt. Since the FIG. 6 embodiment could not operate at 4 psi, the pressure needed to be disadvantageously raised to 7 psi.

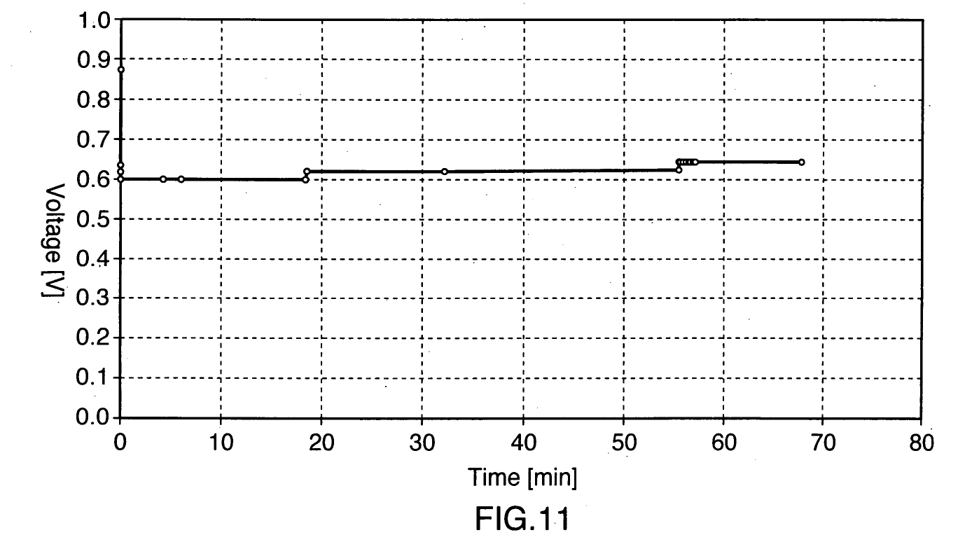

In FIG. 11, the same conditions as for FIG. 9 of the prior art were used, i.e. using a gas diffusion electrode according to the invention at ambient temperature of 21° C., normal atmospheric pressure and hydrogen delivered at a rate of 4 psi. FIG. 11 shows that as time elapsed, there was a steady increase in voltage starting at 0.6 volts and increasing to 0.64 volts after 1 hour, without any fluctuations drops in voltage. This was in stark contrast to the prior art embodiment of FIG. 9 which gave a decrease in voltage over time.

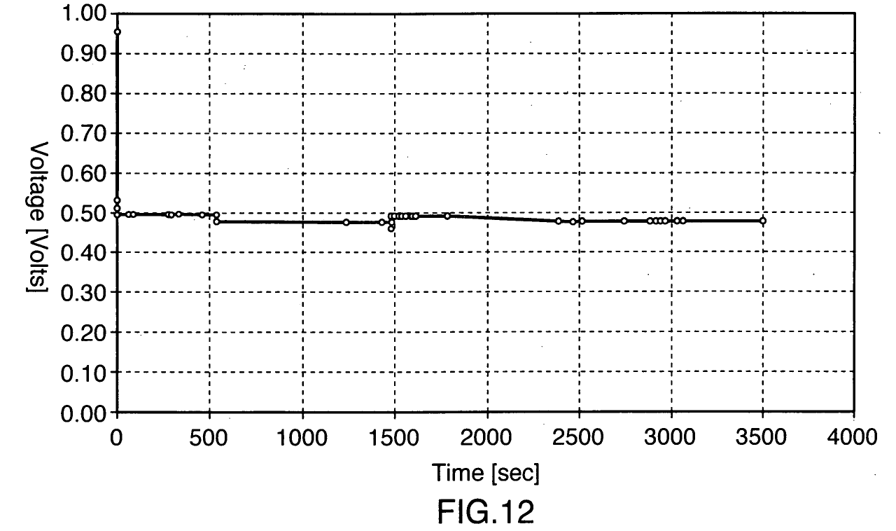

FIG. 12. obtained under the same test conditions as for FIG. 7, clearly illustrates that as time elapsed there were only minor drops in voltage at an average voltage of 0.48.

Although this disclosure has described and illustrated certain preferred embodiments of the invention, it is to be understood that the invention is not restricted to those particular embodiments. Rather, the invention includes all embodiments which are functional or mechanical equivalence of the specific embodiments and features that have been described and illustrated.

1. A fuel cell assembly for use with a source of gaseous reductant and a source of gaseous oxidant, said assembly comprising:
a central ionic membrane having a membrane first surface and a membrane second surface;
a first matrix formed of an organic polymer having a first matrix first surface in contact with said membrane first surface and a first matrix second surface;
a second matrix formed of an organic polymer having a second matrix first surface in contact with said membrane second surface and a second matrix second surface;
a first current collector within said first matrix;
a second current collector within said second matrix and in electrical communication with said first current collector;
wherein each of said first and said second matrices has a pore structure as to allow of gas permeation within the matrix and water exudation out of said matrix, and contains particulate carbon and wherein at least a portion of each of said first and said second matrices contain catalytic material-coated particulate carbon as to constitute a catalytic portion.

2. An assembly as defined in claim 1 wherein each of said matrices is hydrophobic.

3. An assembly as defined in claim 1 wherein said catalytic portions of each of said first and second matrices containing said catalytic material-coated particulate carbon are essentially limited at or adjacent to said first and second matrices second surfaces.

4. An assembly as defined in claim 3 wherein further portions of each of said first and second matrices containing said catalytic material-coated particulate carbon are essentially limited at or adjacent to said first and second matrices first surfaces as to constitute further catalytic portions.

5. An assembly as defined in claim 1 wherein said catalytic material-coated particulate carbon in said first matrix is in electrical contact with said first current collector; and said catalytic material-coated particulate carbon in said second matrix is in electrical contact with said second current collector.

6. An assembly as defined in claim 1 wherein said each of said first and second matrices has at least an effective minimum gaseous porosity.

7. An assembly as defined in claim 6 wherein said each of said matrices has a gaseous porosity of at least 0.1 μm diameter.

8. An assembly as defined in claim 1 wherein each of said current collectors is in the form of a foraminous member to allow of the passage therethrough of gaseous molecules.

9. An assembly as defined in claim 1 wherein each of said current collectors is in the form of a mesh, grid and the like.

10. An assembly as defined in claim 1 wherein each of said current collectors is a metallic conductor.

11. An assembly as defined in claim 10 wherein said metallic conductors are formed of a metal selected from the group consisting of the first transition series metal.

12. An assembly as defined in claim 11 wherein said metal is selected from the group consisting of nickel, copper, iron and alloys thereof.

13. An assembly as defined in claim 1 wherein said catalytic material is selected from a noble metal, a precious metal, and mixtures thereof.

14. An assembly as defined in claim 13 wherein said catalytic material is selected from Pd, Pt, Os, Ir, Ru, Rh, Au and Ag.

15. An assembly as defined in claim 1 wherein said polymer is a high density polyethylene.

16. An assembly as defined in claim 1 wherein said central membrane is formed of of a sulfonic perfluoro polymer.

17. An assembly as defined in claim 1 wherein each matrix has (i) a catalytic material: matrix weight ratio range of 0.01:0.25; and (ii) a catalytic material:particular carbon weight ratio range of 0.01:0.25.

18. An assembly as defined in claim 1 wherein each of said first and second matrices in toto comprises 0.1-2.0 mg catalytic material per g. polymer.

19. An assembly as defined in claim 3 wherein each of said catalytic portions comprises at least 2 mg catalytic material per cm² polymer.

20. A method of preparing a fuel cell assembly as defined in claim 1 comprising embedding said first current collector in said first particulate carbon-containing hydrophobic matrix; embedding said second current collector in said second particulate carbon-containing hydrophobic matrix; locating said central membrane between said first and second matrixes; and treating said first and said second matrixes with a solution of a compound of said catalytic material in an oxidation state to effect reduction to said catalytic material and production of said catalytic material-coated particulate carbon.

21. A fuel cell comprising an assembly as defined in claim 1 and oxidant feed means in communication with said first matrix and reductant feed means in communication with said second matrix.

22. A gas diffusion electrode for use with a fuel cell comprising a matrix formed of an organic polymer having
(i) a pore structure as to allow of gas permeation within and water exudation out of said matrix;
(ii) a first surface;
(iii) a second surface; and
(iv) a current collector embedded within said matrix; wherein said matrix contains particulate carbon and wherein at least a portion of said particulate carbon is coated with catalytic material as to constitute a catalytic portion.

23. An electrode as defined in claim 22 wherein said matrix is hydrophobic.

24. An electrode as defined in claim 22 wherein said catalytic portion of said catalytic material-coated carbon is essentially limited at or adjacent to said first surface.

25. An electrode as defined in claim 22 wherein said catalytic portion of said catalytic material-coated carbon is essentially limited at or adjacent to both of said first and second surfaces.
